(19) United States
(12) Patent Application Publication
(10) Pub. No.: US 2025/0355268 A1
(43) Pub. Date: Nov. 20, 2025

(54) ROTATABLE LIGHTPIPE

(71) Applicant: LUMUS LTD., Ness Ziona (IL)

(72) Inventors: Shimon GRABARNIK, Rehovot (IL); Tsion EISENFELD, Ashkelon (IL)

(21) Appl. No.: 19/283,291

(22) Filed: Jul. 29, 2025

Related U.S. Application Data
(63) Continuation of application No. 17/792,452, filed on Jul. 13, 2022, now Pat. No. 12,372,799.
(60) Provisional application No. 63/023,272, filed on May 12, 2020.

(51) Int. Cl. G02B 27/09; G02B 3/08; G02B 27/01

(52) U.S. Cl. CPC G02B 27/0994; G02B 3/08; G02B 27/0172

(57) ABSTRACT

Based on a rotational axis of symmetry for an output of a lightpipe coinciding with an input axis for projection optics, the lightpipe can be rotated around the rotational axis, in order to align the lightpipe with a frame of associated glasses, or correspondingly the temple of a wearer of the glasses. Thus, an improved or optimal aesthetic look of a display system can be approached. The lightpipe of the display system can be aligned with the frame of the glasses, or even hidden within the frame, depending on implementation details and requirements for image projection components. If a pantoscopic tilt of the lens (waveguide) changes, a rotation of the lightpipe can be applied to the lightpipe to bring the lightpipe in a position aligned with the temple again, thus avoiding the need for a lightpipe redesign.

### FIELD OF THE INVENTION

The present invention generally relates to lightpipes, and in particular, it concerns a lightpipe that can be deployed, without redesign, relative to associated system components.

### BACKGROUND OF THE INVENTION

Pantoscopic tilt is defined as a lens tilt about the horizontal axis, with respect to primary gaze of a subject. In a simple way, pantoscopic tilt can be explained as “the rotation of lens bottom towards the cheeks”. Typically, these tilts range from 0-12 degrees, and tilt between 3-7 degrees are considered normal. Pantoscopic tilt usually depends on how a pair of glasses sits on the user's (wearer's) face.

The amount of pantoscopic tilt varies depending on use and user. Lenses can be used to display images for applications such as augmented reality (AR) and virtual reality (VR). In these cases, components are needed to supply an image for display by a lens. The components can include power supply, image source, light source, optical manipulation and projection. One component that can be used is a lightpipe. The lightpipe is typically used for combining multiple wavelengths of light (for example from an RGB LED light source) and/or homogenizing light uniformity across an exit aperture of the lightpipe for input to optical waveguide device or system.

For aesthetic reasons, it is desirable to have the lightpipe aligned with the frame of the glasses. However, varying components of the system and varying orientation of the components, such as the lens, and the pantoscopic tilt, varies the relative configuration (geometrical relationship) of the associated components, including the orientation of a conventional lightpipe. A conventional solution is to redesign the lightpipe so the lightpipe can be aligned with the frame of the glasses.

### SUMMARY

Based on a rotational axis of symmetry for an output of a lightpipe coinciding with an input axis for projection optics, the lightpipe can be rotated around the rotational axis, in order to align the lightpipe with a frame of associated glasses, or correspondingly the temple of a wearer of the glasses. Thus, an improved or optimal aesthetic look of a display system can be approached. The lightpipe of the display system can be aligned with the frame of the glasses, or even hidden within the frame, depending on implementation details and requirements for image projection components. If a pantoscopic tilt of the lens (waveguide) changes, a rotation of the lightpipe can be applied to the lightpipe to bring the lightpipe in a position aligned with the temple again, thus avoiding the need for a lightpipe redesign.

According to the teachings of the present embodiment there is provided an apparatus including: projecting optics (24) including a spatial light modulator (SLM) (8), the projecting optics having a projecting optics input surface (24N) having an x-axis and y-axis corresponding to an input surface of the spatial light modulator (8), and a lightpipe (2) having a lightpipe axis (30) along a long axis of the lightpipe from a lightpipe input surface (2N) to a lightpipe output surface (2T), and having an output z-axis (10) perpendicular to the lightpipe output surface and the projecting optics input surface (24N), the lightpipe (2) deployed with the lightpipe axis (30) at an oblique angle relative to the x-axis, the y-axis, and the z-axis. In a preferred embodiment, the lightpipe axis (30) is nonparallel to the output axis (10).

In an optional embodiment, further including an anisotropic diffuser (3) configured to accept output light (28T) from the lightpipe output surface (2T) and provide diffused light (28D) toward the projecting optics input surface (24N), the diffuser (3) disposed parallel to the lightpipe output surface (2T) and rotated non-parallel to both the x-axis and the y-axis of the projecting optics input surface (24N).

In another optional embodiment, the anisotropic diffuser (3) has a non-symmetric function scattering light into a wider range of angles in a first direction relative to scattering light into a smaller range of angles in a second direction.

In another optional embodiment, the diffuser (3) is deployed in contact with the lightpipe output surface (2T).

In another optional embodiment, the lightpipe 2 and the diffuser (3) are configured in an illuminating system (26), the illuminating system (26) further including a light source (1) providing input light (28N) via a first Fresnel lens (22A) to a lightpipe input surface (2N).

In another optional embodiment, the illuminating system (26) further includes a second Fresnel lens (22B) and a polarizer (4) via which the diffused light (28D) is provided toward an illuminating system output surface (26T).

In another optional embodiment, the lightpipe (2) is configured in an illuminating system (26), the illuminating system rotatably connected to the projecting optics (24).

In another optional embodiment, the illuminating system (26) further includes an anisotropic diffuser (3) operationally connected to the lightpipe (2) such that the lightpipe (2) and the diffuser (3) rotate synchronously relative to the rotational axis (10). In another optional embodiment, the illuminating system (26) further includes an anisotropic diffuser (3) such that the lightpipe (2) and the diffuser (3) rotate independently relative to the rotational axis (10).

In another optional embodiment, the lightpipe axis (30) is nonparallel to the output axis (10).

According to the teachings of the present embodiment there is provided a method of deploying the apparatus wherein the lightpipe (2) is substantially aligned with a frame axis (110) of a frame (11) of a user's glasses, the frame axis (110) being a longitudinal axis along a frame (11), the frame (11) being between a lens of the glasses and the user's ear.

An apparatus including a lightpipe (2) having a lightpipe axis (30) along a long axis of the lightpipe from a lightpipe input surface (2N) to a lightpipe output surface (2T), and having a rotational axis (10) perpendicular to the lightpipe output surface and projecting optics (24), the lightpipe (2) deployed with the lightpipe axis (30) substantially aligned with a lateral surface (14L) of a geometrical construction of a right circular cone (14) having a vertex (14V) coinciding with the rotational axis (10), the cone having a cone axis aligned with the rotational axis (10), and the vertex (14V) substantially aligned with the lightpipe output surface (2T).

A method of deploying the apparatus of claim 1 wherein a first angle between the rotational axis (10) and a frame axis (110) is substantially equal to a second angle between the rotational axis (10) and the lightpipe axis (30), the frame axis (110) being a longitudinal axis along a frame (11), such that rotating the lightpipe (2) around the rotational axis (10) minimizes a spacing angle (38A) between the lightpipe axis (30) and the frame axis (110), thus aligning substantially parallel the lightpipe (2) with the frame (11).

### BRIEF DESCRIPTION OF FIGURES

The embodiment is herein described, by way of example only, with reference to the accompanying drawings, wherein:

FIG. 1A, a first view of a design of a micro-display projector.

FIG. 1B, a second view of a design of a micro-display projector.

FIG. 2A, and FIG. 2B, a first view and a second view of details of propagation of light in the lightpipe, corresponding to respective FIG. 1A first view and FIG. 1B second view.

FIG. 3A, a display system with the lightpipe 2 not aligned with the frame in the vertical plane.

FIG. 3B, a display system with the lightpipe 2 properly aligned with the frame in the horizontal plane.

FIG. 4A, and FIG. 4B, there are shown a first view and a second view of a cone, the lateral surface on which the lightpipe rotates, corresponding to respective FIG. 1A first view and FIG. 1B second view.

FIG. 5A and FIG. 5B there is shown in each figure a view of the POD integrated with the LOE and the lightpipe rotated (with the same rotation) in relation to the frame.

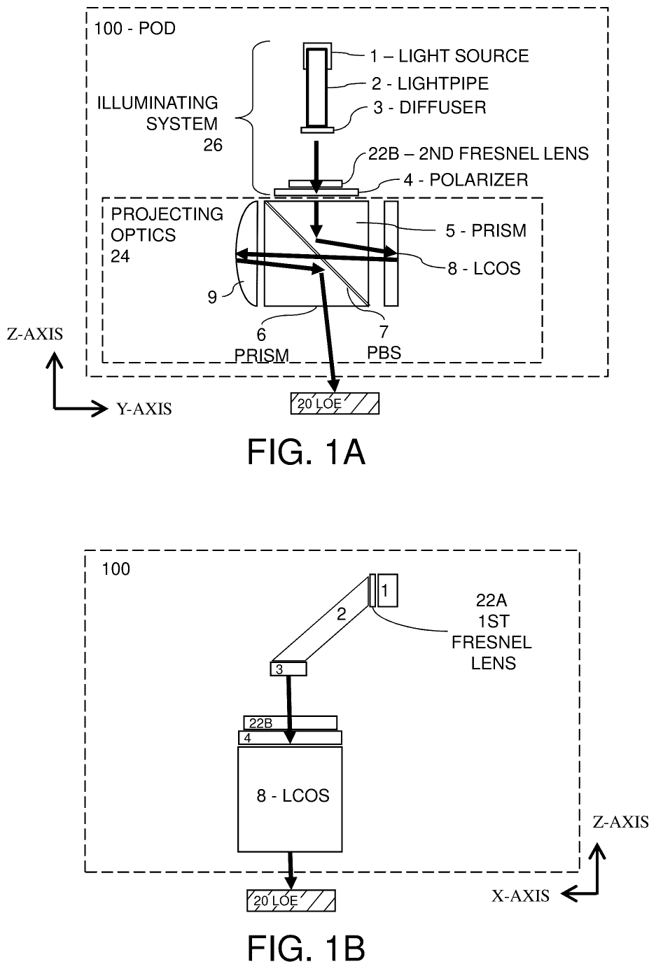

### DETAILED DESCRIPTION—FIGS. 1A to 5B

The principles and operation of the apparatus according to a present embodiment may be better understood with reference to the drawings and the accompanying description. A present invention is an apparatus for rotatably configuring a lightpipe. The apparatus facilitates configuration of a lightpipe with respect to a variety of configurations of associated components, without redesign of the lightpipe.

Based on an axis of symmetry for an output of the lightpipe (rotational axis, output axis), coinciding with an input axis for projection optics, the lightpipe can be rotated on (around) the axis, in order to align the lightpipe with a frame of associated glasses, or correspondingly the temple of a user (wearer of the glasses). Thus, an improved or optimal aesthetic look of the display system can be approached. The lightpipe can be aligned with the frame of the glasses, or even hidden within the frame, depending on implementation details and requirements for image projection components. If a pantoscopic tilt of the lens (waveguide) changes, a rotation of the lightpipe can be applied to the lightpipe to bring the lightpipe in a position aligned with the temple again, thus avoiding the need for a lightpipe redesign.

The lightpipe has an output axis referred to in the context of this description as a “rotational axis”, and the light output from the lightpipe is rotationally symmetrical about this rotational axis. The lightpipe is configured for deployment with a longitudinal axis of the lightpipe at a constant inclination relative to the rotational axis. An extension of the lightpipe axis is not required to be aligned with a PBS (polarized beam splitter, reflecting polarizer) of the projecting optics.

Referring to FIG. 1A, there is shown a first view of a design of a micro-display projector and FIG. 1B, there is shown a second view of a design of a micro-display projector. Elements are not drawn to scale. For simplicity and clarity, typical exemplary components are used in this description. One skilled in the art will realize that other components and configurations can be used. For example, alternate light sources, additional, removal, or alternative lenses in various stages of light propagation, alternative image generation technologies, etc.

An exemplary micro-display projector (POD 100) includes an exemplary illumination system 26 and exemplary projecting optics 24. The exemplary illumination system 26 includes a light source 1, a first Fresnel lens 22A, a lightpipe 2, a diffuser 3, and a second Fresnel lens 22B attached to a polarizer 4. The exemplary projecting optics 24 includes a first prism 5, a polarized beam splitter (PBS) 7, spatial light modulator (for example, a spatial light module, an LCOS) 8, a second prism 6, and a collimator 9. The output of the POD 100 is sent for display, such as to a waveguide, for example a lightguide optical element (LOE) 20.

The light source 1 can be an RGB LED module, for example having three spatially separated LEDs, one each of red, green, and blue. The distinct colors of light generated and output from the light source 1 are typically focused using a first Fresnel lens 22A to concentrate the light for more efficient input (injection) into the lightpipe 2. The input colors are combined (mixed, homogenized) during light propagation in the lightpipe 2 to produce light at an exit aperture of the lightpipe 2, assisted by the diffuser 3 to provide uniform white light irradiance output as input to the projecting optics 24. Typically, the second Fresnel lens 22B is spaced from the diffuser 3.

The illumination system 26 of the current implementation typically outputs polarized light from the polarizer 4. The illuminating system 26 has an illuminating system output surface 26T providing light out from the illuminating system 26 to a projecting optics input surface 24N of the projecting optics 24. The polarized light is received by the exemplary projecting optics 24, propagates via the first prism 5 and is reflected from a first side of a PBS 7 toward a spatial light modulator (SLM), such as exemplary LCOS 8. The LCOS 8 is a non-limiting example of a technology to use the light from the illumination system to generate an image. After reflecting back from the LCOS, the polarization of the image light is rotated by 90 degrees, so the image light propagates through the first prism 5 and passes though the PBS 7 and second prism 6 to the collimator 9. One example of a collimator 9 implementation is using a collimating mirror (such as a spherical mirror or a lens combined with a spherical mirror) integrated with a quarter-waveplate. The collimated image light has a polarization rotated 90 degrees after reflection from the collimator 9, so propagates via second prism 6, and is reflected by the PBS 7. The collimated image light is then output from the POD 100. The output image light is sent to a display, such as to a waveguide, in this case a lightguide optical element (LOE) 20.

The projecting optics input surface 24N has an x-axis and y-axis corresponding to an input surface of the LCOS 8. The two surfaces of the projecting optics input surface 24N and the input surface of the LCOS 8 may be parallel or use a reflected light path to be at a relative angle to each other. The orientation of the two surfaces correspond, being optically equivalent to a straight path from the projecting optics input surface 24N and the input surface of the LCOS 8. In a case where the light path is reflected in the projecting optics 24, and the two surfaces are at a relative angle, the axis will be correspondingly reflected.

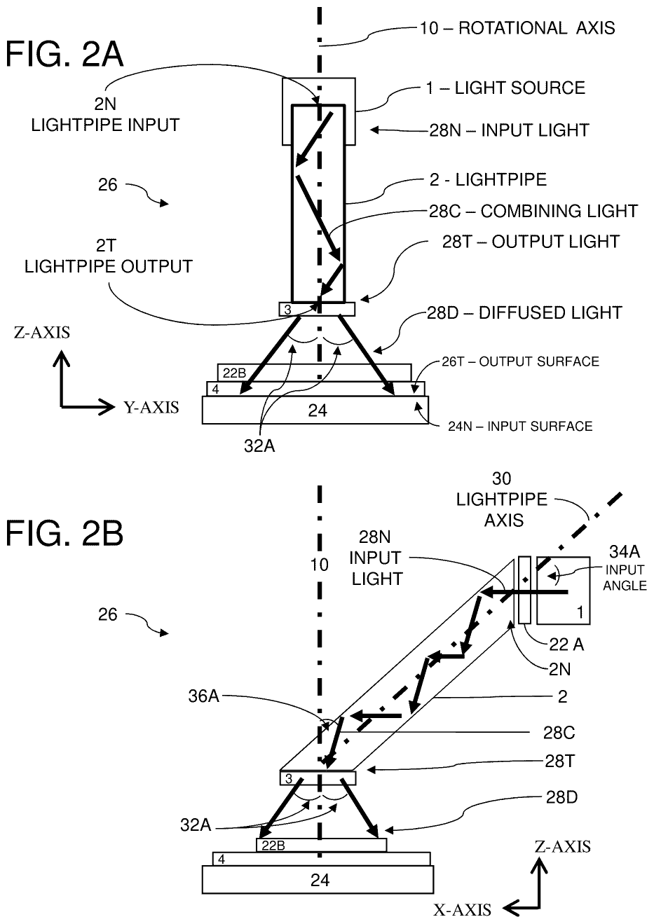

Referring to FIG. 2A, and FIG. 2B, there are shown a first view and a second view of details of propagation of light in the lightpipe, corresponding to respective FIG. 1A first view and FIG. 1B second view. The propagation of light 28C being combined in the lightpipe 2 is typically by total internal reflection (TIR). A rotational axis 10 of the lightpipe 2 is shown perpendicular to the input of the projecting optics 24. The rotational axis 10 is also referred to in the context of this document as the “output axis” and in the figures as the “z-axis”. While this output axis is referred to as a “rotational” axis, this description is not limiting, and implementations include lightpipes 2 and illuminating systems 26 both that rotate and are stationary with respect to the projecting optics 24. A lightpipe axis 30 is shown along a long axis of the lightpipe 2, in a direction propagation of the combining light 28C along the lightpipe 2, typically along a length of the lightpipe 2, from lightpipe input 2N to lightpipe output 2T.

The light generated from the light source 1 enters the lightpipe 2 at the lightpipe input 2N in a cone defined by the input angular aperture of the lightpipe 2. In FIG. 2B, the light from the light source 1 is represented by a single ray of input light 28N entering the lightpipe 2 at an input angle 34A relative to the lightpipe axis 30. The input angle 34A is also referred to in the context of this description as a “first angle”, or simply “input angle”. Correspondingly, after the light 28C propagates and combines through the lightpipe 2, the combined light 28C exits the lightpipe 2 as output light 28T. The output light 28T exits the lightpipe 2 at an angle shown as output light angle 36A. The output light 2T is scattered (diffused) by the diffuser 3 inside a cone defined by a lightpipe output angle 32A (maximum scatter angle, second angle, output angle) relative to the rotational axis 10, providing diffused light 28D. Using a combination of the diffuser 3, the design of the light source 1, and the first Fresnel lens 22A, the radiance of the diffused light 28D exiting the diffuser 3 is substantially rotationally symmetric relative to the rotational axis 10.

A feature of the current embodiment is the innovative insight and realization that the lightpipe 2 can be designed and configured so the output light 28T, and thus the diffused light 28D are approximately rotationally symmetric relative to the rotational axis 10. This feature allows the lightpipe 2 to be tilted relative to the projecting optics 24 (the lightpipe axis 30 is non-parallel to the rotational axis 10). As the lightpipe light output 28T in terms of angular (output angle 32A) and spatial distribution is substantially symmetrical relative to the rotational axis 10, the rotation of the lightpipe 2 around the rotational axis 10 does not impact optical performance of the POD 100.

Another feature of the current embodiment is the preferred implementation of the diffuser 3 as an anisotropic diffuser having a non-symmetric function scattering light into a wider range of angles in a first direction relative to scattering light into a smaller range of angles in a second direction. Optionally, and preferably in addition, the anisotropic diffuser 3 is (input and output surfaces are) parallel and aligned with the lightpipe output surface 2T. Thus, the oblique orientation of the lightpipe 2 corresponds to the diffuser being rotated non-parallel (not aligned) with the projecting optics input surface 24N. That is, the first direction and second direction of the diffuser 3 are rotated, non-parallel, to the x-axis and y-axis of the projecting optics input surface 24N.

Note that for simplicity in the figures, only one light ray is generally depicted. The light can also be referred to as a “light” or “beam”. One skilled in the art will realize that the depicted light (ray) is a sample beam of the actual light, which typically is formed by multiple beams, at slightly differing angles. Except where specifically referred to as an extremity (edge) of the light, the rays illustrated are typically a centroid of the light. In a case where the light corresponds to an image and the central ray is a center ray from a center of the image or a central pixel of the image.

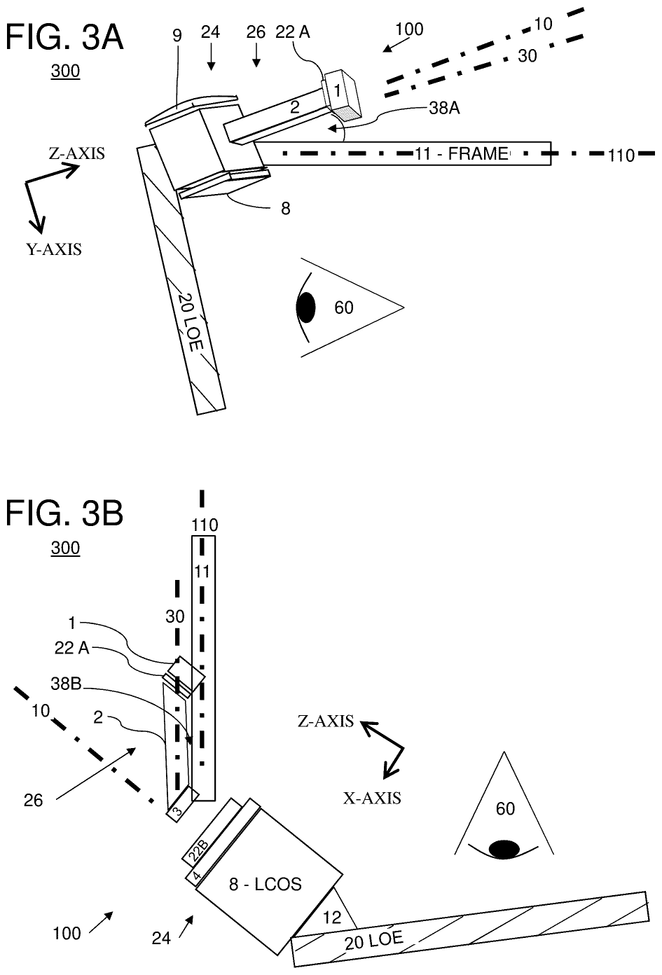

Referring to FIG. 3A, there is shown a view of a display system 300 including the POD 100 integrated with the waveguide (LOE) 20 and in relation to a frame 11 (for example, showing a portion of glasses worn by the user). In the current figure, the lightpipe 2 not aligned with the frame 11 in the vertical plane, relative to the eye 60 of the user. Note that the diffuser 3, the second Fresnel lens 22B, and the polarizer 4 are not shown in the current figure. In this case, the LOE 20 functions as the lens of the glasses. For example, because of the pantoscopic tilt of the waveguide (LOE 20), the illumination system 26 is tilted into the page, hence lightpipe axis 30 is into the page, relative to the projecting optics 24. The lightpipe axis 30 is not coincident with the rotational axis 10. The tilt of the POD 100 relative to the waveguide results in the lightpipe 2 not aligned with the temple of the glass's frame 11. A spacing angle 38A is between the lightpipe 2 and the frame 11 (between the lightpipe axis 30 and a longitudinal axis of the frame 110 along the length of the frame 11). Ideally, there should not be an angle 38A between the lightpipe 2 and the frame 11, that is, the spacing angle 38A should approach and be substantially zero. Where the spacing angle 38A is larger than a given amount, the lightpipe 2 is not aligned with the frame 11, and the resulting aesthetic look of the integration of the display system 300 and glasses is less than the aesthetic look where the lightpipe 2 is aligned with the frame 11.

Referring to FIG. 3B, there is shown a view of a display system 300 including the POD 100 integrated with the LOE 20 and in relation to a frame 11 (for example, showing a portion of glasses worn by the user). In the current figure, the lightpipe 2 is properly aligned with the frame 11, in the horizontal plane relative to the eye 60 of the user. Note, the current figure is simplified, as the POD 100 is actually tilted (rotated) relative to the waveguide (LOE) 20. The spacing angle 38B is substantially zero, having the lightpipe axis 30 aligned in parallel with the longitudinal axis of the frame 110 in the horizontal plane.

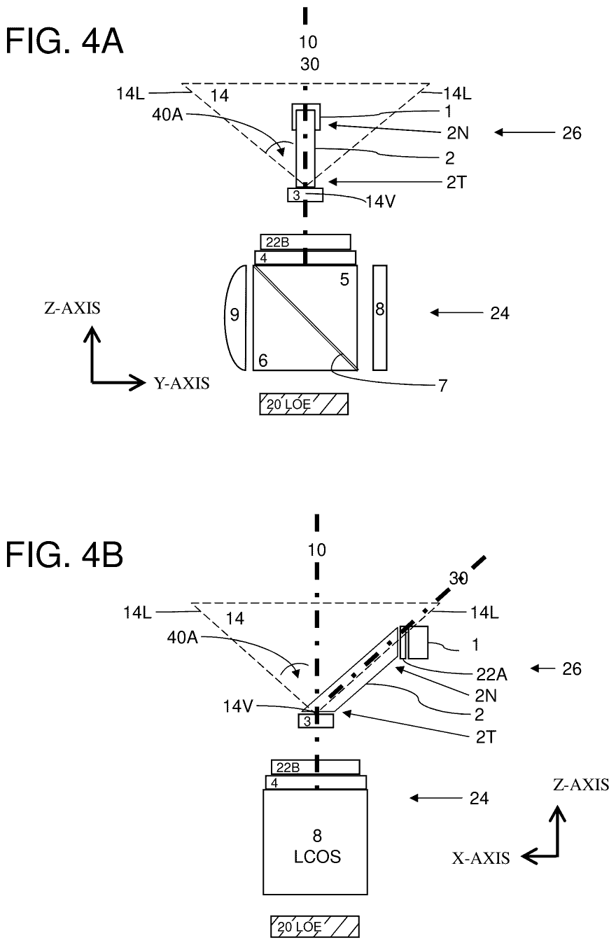

Referring to FIG. 4A, and FIG. 4B, there are shown a first view and a second view of a cone, the lateral surface on which the lightpipe rotates, corresponding to respective FIG. 1A first view and FIG. 1B second view. A geometrical construction of a right circular cone 14 has a vertex 14V coinciding with the rotational axis 10, and the surface of the lightpipe output 2T. The vertex 14V also coincides with the intersection of the lightpipe axis 30. Typically, the surface of the lightpipe output 2T is parallel to the plane of the surface of the diffuser 3, substantially in contact with the diffuser 3, so the vertex 14V also coincides with the intersection of the rotational axis 10 and the diffuser 3. The vertex 14V of the cone 14 typically lies on the surface of the diffuser 3 in a direction of the output light 28T first impinging on the diffuser. The axis of the cone 14 substantially coincides with the rotational axis 10. The cone 14 has a lateral surface 14L. A half-aperture angle 40A is shown in the current figure between the lateral surface 14L and the axis of the cone. The lightpipe axis 30 is substantially aligned with the lateral surface 14L. The vertex 14V of the cone 14 is aligned at the surface of the lightpipe output 2T. The surface of the cone (lateral surface 14L) is formed by sweeping the lightpipe axis 30 around the rotational axis 10. The lateral surface 14L describes possible positions for configuring the lightpipe 2, while maintaining operation of the POD 100, in particular maintaining the radiance of the light (output light 28T, hence diffused light 28D) symmetric relative to the rotational axis 10. One skilled in the art will realize that based on the current description, the lightpipe 2 can be shifted, for example along (in the direction of) the rotational axis 10 (z-axis direction). Note, in FIG. 4B, the lightpipe axis 30 and cone surface 14L are slightly offset for viewing in the figures, as actually the lightpipe axis 30 and cone surface 14L substantially coincide.

For reference, a “vertex” is also referred to in the field of mathematics as an “apex”. The axis of a cone is the straight line (if any), passing through the vertex, about which the base (and the whole cone) has a circular symmetry. The perimeter of the base of a cone is called the “directrix”, and each of the line segments between the directrix and vertex is a “generatrix” or “generating line” of the lateral surface of the cone. The “base radius” of a circular cone is the radius of the circular cone's base; often this is simply called the radius of the cone. The aperture of a right circular cone is the maximum angle between two generatrix lines. For example, if the generatrix makes an angle θ to the axis, the aperture is 20.

A feature of the current embodiment is that the lightpipe 2 can be rotated around the rotational axis 10, while maintaining the vertex 14V at the surface of the lightpipe output 2T and the uniform white light irradiance output of the lightpipe 2 does not depend on (is independent of) this rotation of the lightpipe 2. In other words, the lightpipe 2 can be rotated around the rotational axis 10, while maintaining the lightpipe axis 30 on the lateral surface 14L of the cone 14, and the lightpipe will provide uniform white light irradiance output, which does not depend on the rotation of the lightpipe 2.

By rotating the lightpipe 2 around the rotational axis 10, an orientation of the lightpipe 2 (a position of the lightpipe 2 on the lateral surface 14L of the cone 14) can be found that is at a desirable angle (rotation) (desirable spacing angles 38A and 38B) to the glass's frame 11, and hence the temple of the user (wearer of the glasses), while maintaining operation of the lightpipe 2, illumination system 26, and the POD 100. In a general case, the glass's frame 11 does not lie on the lateral surface 14L. Hence, there may not be a lightpipe rotation around the rotational axis 10 which can make both spacing angles 38A and 38B equal to zero. For example, in FIG. 3A the spacing angle 38A is unacceptably large, while in FIG. 3B the spacing angle 38B is almost zero. An objective of the lightpipe rotation is to find an optimal position of the lightpipe 2 on the lateral surface 14L of the cone 14 that minimizes both spacing angles 38A and 38B, and makes the display system 300 look acceptably well, aesthetically.

The lightpipe 2 can be rotated around an axis, which is an axis of symmetry of the lightpipe light output 2T, in order to align the lightpipe 2 with the temple of the glass frame 11 to achieve a desirable aesthetic look of the display system 300. If a pantoscopic tilt of the waveguide (LOE 20) changes, a rotation of the lightpipe 2 can be applied to bring the lightpipe 2 in a position aligned with the temple again, thus avoiding the need for redesign of the lightpipe 2.

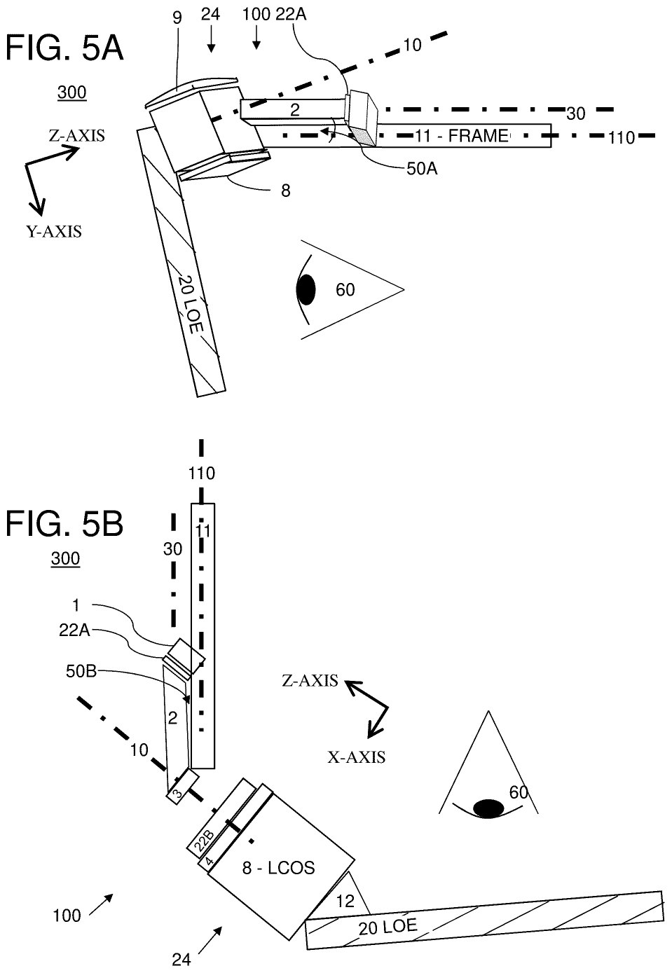

Referring to FIG. 5A and FIG. 5B there is shown in each figure a view of the POD 100 integrated with the LOE 20 and the lightpipe 2 rotated (with the same rotation) in relation to the frame 11. The lightpipe 2 is rotated in such a way that the lightpipe 2 is aligned with the frame 11 acceptably well. Note that in the current FIG. 5A the diffuser 3, the second Fresnel lens 22B, and the polarizer 4 are not shown. Note, the current FIG. 5B is simplified, as the POD 100 is actually tilted (rotated) relative to the waveguide (LOE) 20. In the current figures, the lightpipe 2 is rotated nearly, but not exactly parallel to the frame 11. This can be seen by non-zero angle 50B in the horizontal plane between the lightpipe 2 and the frame 11 (between the lightpipe axis 30 and the axis of the frame 110). Note that in another plane, such as mostly vertical, the angle 50A may be substantially zero. Angles 50A and 50B are defined similar to the above-described angles 38A and 38B. Although not perfectly aligned, a deviation from optimal (substantially parallel) such as non-zero angle 50B may be acceptable within given aesthetic constraints of the glass frame.

Alternatively, a non-zero angle 50B may be desirable to orient the lightpipe 2 and/or the illuminating system 26 and the POD 100. At a desired angle away from the frame 11 of the glasses and/or user to achieve an artistic, design, or aesthetic effect.

While the current description uses the lightpipe 2 as a portion of the exemplary illumination system 26 to provide uniform white light, this description is not limiting. It is foreseen that based on the current description the lightpipe can be deployed in other configurations. One non-limiting example is deploying the lightpipe 2 with an imaging optical element (in place of the light source 1). In this case, the lightpipe 2 carries image information from an image projector near the user's temple, for example in the frame 11 of glasses, to a coupling-in element into the LOE 20. Using the lightpipe 2, image orientation where an image is injected into the LOE 20 will not depend on the rotation of the lightpipe 2 around the rotational axis 10. A compensation can be used, for example, the image projector that is the source of the image could be rotated with and/or independently from the lightpipe 2.

Note that the above-described examples, numbers used, and exemplary calculations are to assist in the description of this embodiment. Inadvertent typographical errors, mathematical errors, and/or the use of simplified calculations do not detract from the utility and basic advantages of the invention.

To the extent that the appended claims have been drafted without multiple dependencies, this has been done only to accommodate formal requirements in jurisdictions that do not allow such multiple dependencies. Note that all possible combinations of features that would be implied by rendering the claims multiply dependent are explicitly envisaged and should be considered part of the invention.

It will be appreciated that the above descriptions are intended only to serve as examples, and that many other embodiments are possible within the scope of the present invention as defined in the appended claims.

What is claimed is:

1. An apparatus (100) comprising:
(a) projecting optics (24) including a spatial light modulator (SLM) (8), the projecting optics having a projecting optics input surface (24N) having an x-axis and y-axis corresponding to an input surface of said spatial light modulator (8); and
(b) a lightpipe (2) having a lightpipe axis (30) along a long axis of the lightpipe from a lightpipe input surface (2N) to a lightpipe output surface (2T), and having an output z-axis (10) perpendicular to said lightpipe output surface (2T) and said projecting optics input surface (24N), said lightpipe (2) deployed with said lightpipe axis (30) at an oblique angle relative to said x-axis, said y-axis, and said z-axis, wherein said lightpipe (2) is configured so that output light (28T) from said lightpipe output surface (2T) is substantially rotationally symmetric relative to said output z-axis (10).

2. The apparatus (100) of claim 1, further comprising an anisotropic diffuser (3) configured to accept said output light (28T) from said lightpipe output surface (2T) and provide diffused light (28D) toward said projecting optics input surface (24N), said diffuser (3) disposed parallel to said lightpipe output surface (2T) and rotated non-parallel to both said x-axis and said y-axis of said projecting optics input surface (24N).

3. The apparatus (100) of claim 2, wherein said anisotropic diffuser (3) has a non-symmetric function scattering light into a wider range of angles in a first direction relative to scattering light into a smaller range of angles in a second direction.

4. The apparatus (100) of claim 2, wherein said diffuser (3) is deployed in contact with said lightpipe output surface (2T).

5. The apparatus (100) of claim 2, wherein said lightpipe (2) and said diffuser (3) are configured in an illuminating system (26), said illuminating system (26) further including a light source (1) providing input light (28N) via a first Fresnel lens (22A) to a lightpipe input surface (2N).

6. The apparatus (100) of claim 5, wherein said illuminating system (26) further includes a second Fresnel lens (22B) and a polarizer (4) via which said diffused light (28D) is provided toward an illuminating system output surface (26T).

7. The apparatus (100) of claim 1, wherein said lightpipe (2) is configured in an illuminating system (26) that is rotatably connected to said projecting optics (24).

8. The apparatus (100) of claim 7, wherein said illuminating system (26) further includes an anisotropic diffuser (3) operationally connected to said lightpipe (2) such that said lightpipe (2) and said diffuser (3) rotate synchronously relative to said output z-axis (10).

9. The apparatus (100) of claim 7, wherein said illuminating system (26) further includes an anisotropic diffuser (3) such that said lightpipe (2) and said diffuser (3) rotate independently relative to said output z-axis (10).

10. The apparatus (100) of claim 1, wherein said lightpipe axis (30) is nonparallel to said output z-axis (10).

11. The apparatus (100) of claim 1, wherein rotation of said lightpipe (2) around said output z-axis (10) does not impact optical performance of the apparatus (100).

12. A method of deploying the apparatus (100) of claim 1, wherein said lightpipe (2) is substantially aligned with a frame axis (110) of a frame (11) of a user's glasses, said frame axis (110) being a longitudinal axis along a frame (11), said frame (11) being between a lens of the glasses and the user's ear.
